(19) United States
(12) Patent Application Publication
(10) Pub. No.: US 2026/0249642 A1
(43) Pub. Date: Aug. 27, 2026

(54) WHEEL COMPONENT FOR A BICYCLE

(71) Applicant: DT SWISS INC., Grand Junction, CO (US)

(72) Inventors: Andreas HENIG, Biel (CH); Fabian BECKER, Biel (CH)

(21) Appl. No.: 19/548,038

(22) Filed: Feb. 24, 2026

(30) Foreign Application Priority Data
Feb. 25, 2025 (DE) 10 2025 107 099.7

(51) Int. Cl. B60B 1/04

(52) U.S. Cl. CPC B60B 1/041; B60B 1/044

(57) ABSTRACT

A wheel component for bicycles including a spoke system having two interacting connecting elements, having a connecting element loaded in tension during operation and designed as a spoke and having at least one connecting element designed as a coupling element, e.g., a spoke nipple. The spoke extends in the axial direction and includes a center piece and two end pieces in order to detatchably connect the spoke to a hub and to a rim by the end pieces. The two connecting elements, namely the coupling element and the spoke, have interacting threads to connect the spoke and the coupling element to one another, wherein one of the threads is designed as an inner thread and one of the threads is designed as an outer thread (60). In the assembled state, a radial depth of engagement of the two threads, screwed to one another, increases across the axial threaded length.

The present invention relates to a wheel component for a vehicle, and in particular for a two-wheel or multi-wheeled vehicle, like a bicycle, that is at least partially muscle-powered in the intended normal or regular operation, and comprises a spoke system having at least two interacting connecting elements, namely having a connecting element designed as a spoke and having a connecting element designed as a coupling element, e.g., a spoke nipple. A spoke of the spoke system comprises a center piece and two end pieces in order to detachably connect the spoke to a hub of a wheel or to a rim of a wheel. The spoke may be manufactured from a fiber composite material and comprises a matrix material and reinforcing elements embedded therein.

Wheels for bicycles made of fiber composite material, in which the spokes are produced directly with the rim, have become known. Such wheels may have a low weight, but they are complicated to produce and difficult to maintain. The entire wheel has to be replaced regularly, even in the case of minor defects, which is not very sustainable. Or the wheel must be laboriously repaired.

A separate spoke made from fiber composite material, produced through an injection molding process, was made known from U.S. Pat. No. 5,350,221. Short-fiber fiber composite material is thereby injected into a cavity of a production mold so that the fiber material is homogeneously distributed in the cavity of the mold. At the one end, the spoke has an angled head and, at the other end, a thread for screwing to a spoke nipple. Such a spoke has not established itself on the market over the last decades. In the same document, a spoke is also described, on which metallic ends are used so that the force dissipating points on the spoke are manufactured from metal.

US 2024/0051333 A1 discloses a spoke made from fiber composite material, wherein initially a central and elongate spoke body is produced by an injection method and has a corrugated structure on the surfaces of the respective ends. A connecting segment with an adapted, corrugated, inner structure is applied onto the corrugated structure. The corrugated structures provide a friction-increasing structure and improve the axial holding by the connecting segment and by the spoke body. By this means, a sliding of the connecting segment along the spoke body is to be prevented. Wider thread turns in the axial direction are formed by a sawtooth thread, which improves the transferability of axial tensile forces. It is questionable whether the spoke withstands higher loads.

A spoke made from a fiber composite material, in which the spoke body is produced by a pultrusion process, was made known by EP 3 459 759B1. Stepped surfaces and angled areas are provided on the spoke body, made from fiber composite material, onto which angled areas the bushings are applied, which consist of stainless steel and establish the connection to the hub or to the rim. Such a spoke basically works; however, it is complicated to produce.

A reinforced fiber spoke for a bicycle is known from WO 03/020535A2, which has an elongate spoke body, on which bushings are applied before the ends of the spoke body are thickened, in order to thus hold the separate bushings on the spoke body. The bushing provided for fastening the spoke to the rim has a spherical seat in order to enable an alignment of the spoke. The bushing at the other end comprises an outer thread in order to screw the spoke to the hub using a corresponding thread. The spoke body is produced by pultrusion. This spoke is also functionally satisfactory and enables a light weight. However, the significant production costs are disadvantageous.

Furthermore, it is desirable to improve the stability of the spoke system.

It is therefore the object of the present invention to provide a wheel component with a spoke system which is able to withstand high loads. In particular, the spoke system should be easy to produce and to assemble, and the tension should be adjustable.

This problem is solved by a wheel component with a spoke system having the features of claim 1, and by a wheel component with a coupling element having the features of claim 18. Preferred refinements of the invention are the subject matter of the subclaims. Additional advantages and features of the present invention arise from the general description and the description of the exemplary embodiments.

A wheel component according to the invention for a vehicle and in particular for a bicycle comprises (at least) one spoke system having two interacting connecting elements (spoke units), namely a connecting element (loaded in tension during operation and) designed as a spoke and having at least one connecting element designed as a coupling element, e.g., a spoke nipple. Other coupling elements may also be used. The connecting elements and, in particular, a spoke, a coupling element, and a spoke nipple, may also be designated as spoke units. The spoke extends in the axial direction (and is, in particular, designed as straight and elongated) and has a center piece and two end pieces, in order to detachably connect the spoke to a hub (of a wheel) and to a rim (of the wheel) by means of the end pieces.

The coupling element and at least one end piece of the spoke have interacting threads in order to connect or screw the spoke and the coupling element to one another, wherein one of the threads is designed as an inner thread and one of the threads is designed as an outer thread. In an assembled state, a radial depth of engagement of the two threads screwed to one another increases across at least one (significant) part (of an axial length of one or both thread/s and/or one significant part of an engagement length of the two threads). By this means, the strength of the connection of the spoke system may be significantly increased.

The wheel component according to the invention has many advantages. One significant advantage of the wheel component according to the invention consists in that the load capacity may be improved. The spoke system may transfer high tensile forces. In principle, loads during operation must be dissipated by the threads of the connecting elements. This means that the teeth of the threads must permanently dissipate the load. The teeth extend in a cross section (through the longitudinal axis) outward from the regular, rotationally symmetrical body portion of the thread.

It is now advantageous that the radial depth of engagement increases along the longitudinal axis or in the axial direction. The radial depth of engagement may also be designated as a radial overlap of the threads or of the teeth of the thread. The increase of the radial depth of engagement enables a significantly better load distribution across the axial direction. Due to this, the first complete winding of the thread, which is located in the engagement, need not carry the highest load component. A significantly better load distribution is possible across the engagement length. This increases the stability and also the strength of the threaded connection. The risk of tearing off is lower. In addition, a creeping of the material of one or both threads is reduced. Overall, the resilience and durability are improved. Once set, a spoke tension is retained longer.

In preferred embodiments, the radial depth of engagement decreases in the direction toward an axial center of the spoke. The radial depth of engagement preferably increases with a distance from the hub.

The coupling element is preferably screwed onto one end of the spoke, and particularly onto one end piece of the spoke. The radial depth of engagement then (continuously or quasi-continuously) decreases, particularly preferably in the direction toward the other end piece of the spoke across a length of the thread of the coupling element.

In all embodiments, the coupling element has, in particular, a head end with a contact surface for support. The head end with the contact surface functions, in particular, for generating a spoke tension at a component, like the hub or the rim. The contact surface is preferably designed as rounded. The radial depth of engagement then decreases across an axial length of the coupling element in the direction toward the head end of the coupling element.

In one particularly preferred refinement, one of the two interacting threads is designed as conical. This means, in particular, that a core diameter and a thread diameter run conically. The thread in the coupling element is, in particular, designed as conical toward the head end.

It is also possible that one of the two interacting threads has an increasing thread depth across at least one (significant) part (of the axial threaded length) and is, e.g., designed as conical. A radial depth of engagement of the thread then increases in one axial direction (and decreases in the other axial direction).

In particular, the spoke has an outer thread and the coupling element has an inner thread. In an assembled state, the two connecting elements are screwed to one another.

The connecting elements respectively have, in particular in the area of the threads, a base body and teeth projecting radially (outwardly or inwardly) therefrom. The base body and the teeth are thereby integrally designed. A tooth shape of the thread of the spoke may correspond to a tooth shape of the thread of the coupling element.

It is particularly preferred that the tooth shape of the thread of the spoke significantly differs from a tooth shape of the thread of the coupling element. That may significantly increase the strength of the connection of the spoke system. Particularly if the teeth consist of different materials.

The teeth may form a completely circumferential thread path or multiple circumferential thread paths. The coupling element and the spoke respectively and in particular have (at least) one thread path. A thread path may be continuous. It is also conceivable that a plurality of individual teeth project radially from the base body. The plurality of individual teeth then forms at least one thread path. In such a constellation, the actually projecting individual teeth may be spaced apart from one another along the thread path.

Preferably, (at least) one continuous thread path is formed, on which the thread has, in cross section, the shape of one of the teeth projecting from the base body.

In one preferred embodiment, the connecting elements respectively have, in a cross section through the longitudinal axis (axis of symmetry), a base body and teeth projecting on the threads radially (outwardly or inwardly) therefrom. In cross section, a tooth shape of a tooth of the thread of the spoke may substantially differ from a tooth shape of a tooth of the thread of the coupling element. That may increase the strength of the connection of the spoke system overall. Particularly in the assembled state, the two teeth are thereby arranged adjacently on the connecting elements and contact one another. The teeth, or the thread paths thereby formed, support one another.

In all embodiments and refinements, the inner thread preferably has an increasing free inner diameter across at least one (significant) part (of the axial threaded length). The inner thread may designed, e.g., as conical. A radial depth of engagement of the thread increases in an axial direction. It is particularly preferred that the (radial) depth of engagement of the two threads in an assembled state decreases in an axial direction toward the spoke center. The spoke center is preferably at the center piece between the end pieces of the spoke. The thread is thus unloaded at the outer end. The radial overlap increases from the hub-side end to the center of the spoke. A better load distribution arises in the spoke.

The basic principle is that, the smaller the diameter becomes during screwing in (the father the spoke is screwed into the spoke nipple using the threads), the more contact surface (radial depth of engagement) is provided in the radial direction, and the more identical the load distribution becomes in the thread. The contact surface increases quadratically with the radial depth of engagement. Such an embodiment is advantageous, because the first thread turns carry the main load in a parallel thread. By this means, the load is better distributed across the length of the thread.

In the assembled state, a radial depth of engagement or a radial overlap of the threads preferably increases (continuously) over a substantial part of the engagement length by a total of at least 10% and particularly at least 15%, 20%, or by at least 25%. A contact surface resulting therefrom preferably increases by at least 20% or 30% or 40% or more. 50% or more is also possible.

A free inner diameter of the inner thread in the coupling element (or spoke nipple) preferably increases or decreases (monotonically and particularly preferably strongly monotonically in the mathematical sense) across an axial length of the inner thread (depending on the direction it is viewed from).

A radial depth of engagement may constantly increase from tooth to tooth, particularly in the axial direction. This may be implemented across a series of teeth or across (virtually) all teeth (windings).

In particular, an inner contour of the inner thread in the coupling element (or spoke nipple) is designed as approximately conical. The inner contour does not have to increase linearly in the radial direction across the axial length. The inner contour may also have a free inner diameter that increases quadratically or exponentially. The inner contour may then have a trumpet-like profile.

An opening angle of the inner thread in the coupling element (spoke nipple) is preferably designed overall as approximately conical (at least in segments) in the axial direction.

It is thereby preferred that the inner thread in the spoke nipple is designed approximately conically (or trumpet like or similar).

In principle, a type of conical profile preferably results. The profile may, however, also be stepped. This also results (in principle) in a type of conical contour across the length. Likewise, the profile may also be non-linear. A corrugated profile may also be designed, which has an increasing free inner diameter (in cross section).

In preferred embodiments, an opening angle of the inner contour of the inner thread is preferably between 0.5° or 1° and 7° (or up to 8° or 10° or more). The opening angle is a type of cone angle and is preferably between 1.5° and 6° and in particular between 2.5° and (4° or) 5°. In one specific attempt, good results were achieved at an angle of 3°. The opening angle preferably corresponds to a cone angle for a conical thread.

The inner contour of the inner thread in the coupling element (or spoke nipple) is preferably designed as conical (and opens) in the direction of the (axial center of the) spoke. The inner contour of the inner thread in the coupling element is designed as opening in the direction of the end (insertion end) on which a spoke is inserted for screwing in.

A core diameter of the inner thread in the coupling element (and in particular in the spoke nipple) runs (approximately) conically in the axial direction (at least across the engagement length in the assembled state). The profiles of the core diameter and the inner diameter may run analogously and, in particular, (approximately) parallel.

In other embodiments, the core diameter of the inner thread may also be constant. Other profiles of the core diameter of the inner thread are also possible. The overlap of the teeth/windings of the thread are not influenced by the profile of the core diameter in the case of a cylindrical counter thread.

In certain and also preferred embodiments, both threads are designed as conical, at least in portions, wherein an opening angle of the one thread, and preferably of the inner thread, is then significantly larger than an opening angle of the other thread, and preferably of the outer thread. An opening angle, resulting as the difference of the two different opening angles of the inner and outer threads, is then preferably between 1° and 6° and particularly between 2° and 5°.

In all embodiments, an opening angle of the thread of the spoke is preferably less than 1° or 2°.

In specific, preferred embodiments, the other of the two threads (and in particular the outer thread of the spoke), is designed as substantially cylindrical. In particular, an angle of less than 0.5° is thereby also considered to be cylindrical. The axial length of the two threads is usually not so large that a minimum angle plays a role.

In particular, a core diameter of the inner thread in the coupling element (or spoke nipple) changes less across a length of the inner thread and/or across an engagement length of the two threads than the free inner diameter of the inner thread. The core diameter may also not change at all.

In preferred embodiments, the core diameter of the inner thread is at least substantially constant across the length of the inner thread. A cylindrical profile is preferred.

It is preferred that the connecting elements respectively have, in the area of the threads, a base body and teeth projecting radially (outwardly or inwardly) therefrom, wherein a tooth shape of the thread of the spoke differs significantly from a tooth shape of the thread of the coupling element. By this means, the strength of the connection of the spoke system may be increased.

In one embodiment, the thread turns in one cross section respectively have a tooth, projecting radially outwardly or inwardly from the base body of the connecting elements, and a tooth shape of the thread of the spoke in the cross section differs significantly from a tooth shape of the thread of the coupling element in order to increase the strength of the connection of the spoke system.

The tooth shapes preferably differ. regardless of how a tooth shape is viewed, whether rotated or in mirror image, a significant difference remains. The term “tooth shape” thereby includes not only the geometric shape, but also its size. An identical tooth shape is only present if the teeth are geometrically (virtually) congruent. The teeth of the two threads engage with one another.

If the teeth of the threads differ, this offers opportunities for improving the strength. Thus, different materials and/or wall thicknesses may be used.

The strength may be improved. In particular, the shearing strength may thus be improved. It is also possible to improve the creep behavior. If both the shearing strength and creep behavior are improved, the strength, and thus in particular also the fatigue strength, are increased to a particular extent. That is advantageous, in particular for spoke systems which use different material combinations or parts made from fiber composite materials. The increased strength contributes to a higher service life and lower maintenance.

In the case of threads, a cross section of the inter-engaging teeth from spoke systems for bicycles from the prior art is usually identical or virtually identical. This is, advantageously, not the case here.

In preferred embodiments, the connecting element, or the spoke unit with an outer thread, has a base body. The base body has a core diameter or defines a core diameter. The core diameter appears, in particular, at a thread root. A tooth (projecting from the base body) of the outer thread has a (defined) tooth shape and extends from the base of the tooth radially outward. The base of the tooth is defined by the core diameter (or the base body). From there, the tooth projects radially outward. The tooth having the tooth shape comprises two tooth flanks (i.e., thread flanks). The tooth flanks define a flank angle with one another. A thread depth results from the difference of the (local) outer diameter and the (local) core diameter. The result, divided by two, yields the thread depth. A crest of the tooth faces radially outward in the case of the outer thread.

In preferred embodiments, the connecting element, or the spoke unit with an inner thread, (likewise) has a base body. The base body of the connecting element with an inner thread has a core diameter or defines a core diameter. The core diameter (likewise) appears at a thread root. The tooth (of the inner thread) has a (defined) tooth shape and extends radially inward from the base body having a core diameter. The tooth having the (defined) tooth shape comprises two tooth flanks (i.e., thread flanks). The thread flanks define a flank angle to one another. A thread depth (of the inner thread) results from the difference between a (local) minimum (free) diameter (inner diameter) and a (local) core diameter. The result, divided by two, yields the (localized) thread depth. A crest of the tooth of the inner thread faces radially inward.

In all embodiments, the thread is designed on a spoke, in particular at an end piece, and extends there, in particular, up to the end.

It is preferred that at least the teeth of the connecting elements consist at least partially of different materials. This enables a targeted configuration.

In particular, a characteristic value of the tooth shape of the thread of the spoke differs by more than 10% from a characteristic value of a tooth shape of the thread of the coupling component. Preferably, the characteristic value of the tooth shape of the thread of the spoke differs by at least 15%, 20%, 25%, 33% or by 50% or more from the characteristic value of a tooth shape of the thread of the coupling component. A characteristic value may thereby describe or represent a value, such as, in particular, a dimension, a surface, or a volume.

It is possible that a difference factor of a dimension of the tooth shape of the one connecting element to a (corresponding) dimension of the tooth shape of the other connecting element is at least 110% or at least 120% or more. A difference factor of 1.1 or 1.15 or 1.2 or 1.3 or 1.4 or 1.5 or more is preferred.

In particular, a characteristic value of the tooth shape of the thread of the spoke is significantly larger than a characteristic value of a tooth shape of the thread of the coupling component.

In advantageous refinements, an axial length of a base of the tooth shape of the thread of the one connecting element differs significantly from an axial length of a base of the tooth shape of the thread of the other connecting element. A base of the tooth shape of the spoke thread is preferably longer than a base of the tooth shape of the coupling component or the spoke nipple.

An axial length of a base of the tooth shape of the spoke thereby corresponds to the axial length of the tooth at the tooth root or at the base body. This corresponds to the axial spacing (e.g., the beginning or end) of two thread roots of the thread.

A cross-sectional surface of the tooth shape of the thread of the one connecting element is preferably significantly larger than a cross-sectional surface of a tooth shape (of a tooth) of the thread of the other connecting element.

A cross-sectional surface of the tooth shape of the spoke thread is preferably larger than a cross-sectional surface of the tooth shape of the spoke nipple thread. A cross-sectional surface of a tooth shape is thereby understood as the surface from the base up to the crest.

The volume of a thread path is, in particular, taken into consideration. That is calculated from the cross-sectional surface and the circumference.

In all embodiments, the two threads are adapted, in particular, to one another and largely fill the surfaces and the volumes between the connecting elements. At least across the length of the engagement of the two threads.

The two threads, screwed to one another, usually fill at least 80% or 90% or 95% or more of the volume between the connecting elements.

A minimum radial distance of a crest of one tooth to an associated thread root is preferably less than 1/4 or ⅕ or ⅛ or 1/10 of a thread depth. The thread depth corresponds to the radial tooth height from a thread root to the crest of the tooth.

A thread depth is preferably as large as possible in the case of a coupling element made from a fiber composite material in order to increase the contact surface.

A projected surface of the contact surface is important for the compressive load that occurs. If the compressive strength of a material of a spoke unit is smaller than the necessary contact surface, which is needed for the compressive strength, this may lead to crack formation and also to creeping. A corresponding tooth height is therefore advantageous.

At a radially middle point, an axial length of a tooth of the connecting element is preferably significantly larger than an axial length of the other connecting element (at the same radially middle point). In particular, an axial length of a tooth of the one connecting element at the flank diameter of the thread is preferably significantly larger than an axial length of the other connecting element at the corresponding flank diameter. The term “tooth width” is understood to mean, in particular, a length in the axial direction.

An axial width in a radially middle area of a tooth shape of the spoke thread is preferably larger than the axial width of the tooth shape of the spoke nipple thread (at the same radial point). In the case of coupling elements or spoke nipples made from, e.g., metallic materials and spokes made from a fiber composite material, this may also be reversed.

The strengths of the two threads preferably differ (overall) by less than 50%, preferably be less than 30% or 20% or less than 15%.

It is particularly preferred that a product, with a value between 0.5 and 2.0, and preferably between 2/3 and 3/2 and particularly with a value between 3/4 and 4/3, results from a ratio of the shearing strength of the material of the teeth of the one connecting element to the shearing strength of the material of the teeth of the other connecting element, multiplied by a ratio of an axial length of the teeth of the other connecting element to an axial length of the teeth of the one connecting element at at least one radial point. It is particularly preferred that the product is a value between 0.75 and 1.25 or between 0.9 and 1.1. Consequently, virtually identical strengths of the interacting threads, and thus a high (total) strength of the threaded connection.

It is particularly preferred that a product, with a value between ⅔ and 3/2 and preferably between 0.75 and 1.25, results from a ratio of the creep behavior of the material of the teeth of the one connecting element to the creep behavior of the material of the teeth of the other connecting element, multiplied by a ratio of an axial length of the teeth of the other connecting element to an axial length of the teeth of the one connecting element at at least one radial point.

The strength preferably represents the shearing strength and the creep behavior. The strength then depicts a particularly good measurement for the durability.

One preferred goal is that the strengths, and in particular the shear strength and shearing strength of the two connecting elements are virtually identical, in order to be able to compensate for a weakness of the weaker material.

In particular, the radial depth of engagement of the two threads in the assembled state increases in the axial direction toward the spoke center. This has the advantage that a more uniform loading of the windings of the threads occurs. A largest load is not (necessarily) taken on by the first thread turn, as the depth of engagement increases at an increasing distance. Thus, all parts of the thread may carry an optimal load. This is very advantageous, in particular in the case of spokes made from fiber composite materials and particularly preferably in the case of spokes with thermoplastic matrix material. Or in the case of spokes made from metal and coupling elements made from fiber composite materials.

In particularly preferred embodiments, at least one thread is designed as asymmetrical in the axial direction. In particular, at least one thread may be taken from a group of threads, said group comprising a sawtooth thread, a round thread, and a trapezoidal thread, and more of the same. The terms sawtooth thread, round thread, and trapezoidal thread are also understood to mean thread types which are configured similarly thereto. It is particularly preferred that both threads are adapted to one another. This means that, when using, e.g., a sawtooth thread, the other thread is usually also designed as a type of sawtooth thread, or the shape is based thereon.

In particular, the (two) connecting elements consist, to a significant proportion, of different materials.

In preferred embodiments, the coupling element comprises at least one metallic material or consists virtually completely or completely thereof.

It is preferred that the spoke consists at least partially of a fiber composite material with at least one matrix material and reinforcing elements. The material of the thread of the spoke comprises, in particular, at least one matrix material. Reinforcing elements may be present in the matrix material of the thread. However, it is also possible that no reinforcing elements are present in the area of the thread.

In other preferred embodiments, the spoke consists at least partially of a metallic material and the coupling element consists at least partially of a thermoplastic or duroplastic material, and in particular of a fiber composite material having at least one matrix material and reinforcing elements.

The end pieces are preferably designed integrally with the center piece and respectively form an end of the spoke. At least some of the reinforcing elements are designed in particular as long fibers and extend in a cross-sectional area completely through the center piece and respectively across at least a substantial part of at least one, or preferably both, end pieces. Or the long fibers extend virtually completely or completely through the end pieces.

Long fibers may contribute significantly to stability, in particular if they extend (each integrally) from one end to the other end of the spoke. Long fibers are, in the meaning of this application, continuous fibers.

If an asymmetrical profile with different flank angles is present, high forces may be transferred along the spoke system in the axial direction.

In particular, a light and easily manufacturable wheel component is provided, which is highly resilient.

The end pieces, designed integrally with the center piece, enable a high load capacity and prevent settling phenomena, which may occur in the case of multi-part spokes. This can negatively affect the spoke tension and the centering of a wheel. This is prevented in the case of the invention.

The spoke may be substantially produced by pultrusion, wherein the end pieces or parts thereof are then injection molded on the center piece, while the matrix material of the center piece is still liquid, or after it has been made semi-liquid or liquid. An (in particular jointless and) integrally-formed wheel component thus results, for which no adhesions, glue layers, or separating boundary layers are present, even in the interior of the spoke. A material connection is created. It is conceivable that boundary layers, or rather boundary areas, are visible at the microscopic level. However, there is definitely no separate intermediate layer, like a glue layer, present. In a sectional view, a change from one material of the reinforcing elements and/or in the size and the size distribution of the reinforcing elements is visible. In simple cases, the fiber material and/or the fiber dimensions change, and preferably no boundary layer and/or no transition is visible in the matrix.

The spoke has, in particular, a spoke body, designed as straight and elongated, which comprises a center piece and two end pieces designed integrally therewith on its ends, located opposite and spaced apart from one another. The spoke is designed, in particular, as straight and has no bend. Spokes, e.g., made from metallic materials, may also be designed as bent at one end.

The spoke body preferably has no through holes or depressions, at which other parts may be hooked in. The surface of the connecting elements is, with the exception of the threads, preferably designed as smooth and has no hooks or eyelets.

Long reinforcing fibers and, for example, continuous fibers, are used as long fibers in the connecting elements and are correspondingly cut to the length of the spoke, for example, after a or the pultrusion. Stated succinctly, in the context of this application, long reinforcing fibers are also called long fibers (or “continuous fibers”). “Continuous fibers”, because they were continuous in production and/or because they extend from one end of the spoke to the other end of the spoke or of the coupling element.

In one preferred embodiment, at least one end piece has a larger outer diameter than at least one transverse dimension in the center piece. In particular, at least one outer diameter of an end piece is larger than a minimum transverse dimension and/or an average transverse dimension and/or a maximum transverse dimension in the center piece.

A transverse dimension is thereby understood to mean a dimension aligned transversely or perpendicular to the longitudinal axis or to the axis of symmetry of the spoke. In simple embodiments, the transverse dimension may be the diameter in a central area of the center piece.

In one preferred embodiment, at least one end piece and, in particular at least one head portion, has a thickened portion (directly or also indirectly) adjacent to the center piece of the spoke and a support portion connecting in turn thereto. The thickened portion, manufactured integrally with the entire spoke body, ensures, together with the support portion, a reliable support for the spoke. In the thickened portion, at least one dimension of the spoke expands transversely to the longitudinal direction of the spoke. In all embodiments, the thickened portion may be configured like a cone. The thickened portion may then also be designated as a conical portion.

This thickened portion or also conical portion may also have a function of holding the spoke during wheel assembly, so that no damage occurs to the spoke due to twisting.

Preferably, at least one of the end pieces has a threaded portion (with the thread) for screwing to a spoke nipple. Preferably, at least one of the end pieces has a head portion for supporting the spoke. It is possible and particularly preferred that one of the end pieces comprises a head portion for supporting the spoke and the other end piece comprises threaded portion for screwing to a spoke nipple. However, it is also possible that threaded portions are designed at both ends.

It is also possible that a head portion with a threaded portion designed thereon is included at both ends. Then, e.g., a thickening may be included as the head portion on both ends, wherein a (cylindrical) threaded portion is designed on the head portion. This facilitates flexible usage.

In advantageous refinements, at least one end piece comprises a cross-sectional area with long fibers embedded therein as reinforcing elements, and at least one cross-sectional portion with shorter reinforcing elements embedded therein or without reinforcing elements. The shorter reinforcing elements are thereby designed as shorter than the longer reinforcing elements or long fibers. The shorter reinforcing elements are particularly preferably shorter than ⅕ or 1/10 the length of the long fibers. The length of the long fibers corresponds, in particular, approximately or substantially to the spoke length or to the length of a spoke nipple and achieves or exceeds at least 90% or 95% or 99% of the length of the spoke or of the spoke nipple. Preferred variants of shorter reinforcing elements, which are designed as fibers, may also be designated as short fibers in the context of this application.

It is possible that the cross-sectional portion is designed as free of long fibers. It is preferred that the cross-sectional portion comprises a lower proportion of long fibers than the cross-sectional area (provided with long fibers). It is particularly preferred that the central area of the center piece is a cross-sectional area with (exclusively) long fibers as reinforcing elements. Since the long fibers run, in principle, through the entire spoke, there are also long fibers at the ends (in the radial center or surrounding the same).

At least one part of the reinforcing elements are preferably formed by short fibers, which are designed as significantly shorter than the long fibers.

A cross-sectional area may also be designated as a long fiber area, and a cross-sectional portion may also be designated as a short fiber area. Short fibers are to be understood in the context of this application in particular as reinforcing fibers, which have a length between 0.1 mm or 0.2 mm and approximately 3 cm. Short fibers shorter than 10 mm are particularly preferred.

It is preferred that a significant part of the cross-sectional area has exclusively long fibers as reinforcing elements.

It is also possible and preferred in all embodiments, that a significant part of the cross-sectional portion (or the whole cross-sectional portion) has no reinforcing elements or exclusively shorter reinforcing elements (for example, in the form of short fibers or other reinforcing elements).

In preferred embodiments, at least one part of the shorter reinforcing elements is formed by fiber snippets and/or reinforcing particles. Fiber snippets are, in particular, flat elements. Reinforcing particles may be spherical elements, powder particles, or also irregular particles.

It is also possible that the cross-sectional portion has no or only a small amount of reinforcing elements, so that a proportion by weight of reinforcing elements in the cross-sectional portion is much lower than a proportion by weight of reinforcing elements in the cross-sectional area. A lower amount of shorter reinforcing elements may be contained in the cross-sectional area. It is also possible that virtually none or absolutely no reinforcing elements are present in the cross-sectional area.

Preferably, in the case of threads that are asymmetrical in the axial direction, the shallower thread flank is respectively aligned in the assembled state in the tensile direction and forms the load-bearing flank (or the load-bearing flank of the thread). In particular, the shallower thread flank has an angle of less than 10° or less than 8° perpendicular to the longitudinal direction. The steeper thread flank has, in particular, an angle greater than 20° or 25° perpendicular to the longitudinal direction, and forms a non-load-bearing flank. The steeper thread flank has, in particular, an angle less than 60° or 50° perpendicular to the longitudinal direction. A flank angle between the thread flanks is preferably between 25° and 60°.

Load-bearing and non-load-bearing flanks are thus provided, and two different values result for the flank angle, namely, respectively different angles between the thread flank and a line standing perpendicular to the axial direction. The flank angle of the sawtooth thread then arises from these two values. For example, a type of metric sawtooth thread may be used, in which the angle at the load-bearing thread flank is 3° and the angle at the non-load-bearing thread flank is 30°. The flank angle between the two thread flanks is then (approximately) 33°. This is along the lines of DIN 513-1 to DIN 513-3, where, however, larger diameters, from 10 mm to 640 mm, are defined, and not very small thread dimensions, as are used in this case.

It is also possible to configure the threads with reference to an American ANSI sawtooth thread. The angle of the non-load-bearing flank may then be 45° and 7° at the load-bearing flank. Deviations are possible.

Straight, one-sided loads may be dissipated well by such a structure. That is the case in spoke systems, which are practically only loaded in tension. The load-bearing thread flank is approximately perpendicular to the axial direction and may thus dissipate the very high dynamic forces in spoke systems in the axial direction.

In all embodiments, it is particularly preferred that a maximum thread diameter of an outer thread (of a spoke unit or of a connecting element) is less than 8 mm and preferable less than 5 mm. In particular, a minimum thread diameter of an inner thread is greater than 1 mm or greater than 1.5 mm or greater than 2 mm. The maximum thread diameter thereby corresponds, in particular, to the outer thread diameter and the minimum thread diameter of an inner thread corresponds to the clear inner diameter.

A thread pitch (of an inner and of an outer thread) between 0.3 mm and 0.9 mm is particularly preferred.

A difference in diameter from a maximum thread diameter to a minimum thread diameter (of the same thread) is preferably between 0.5 mm and 1.5 mm.

In all embodiments, it is possible and also preferred that the spoke nipple consists at least partially of (at least) one metal. The spoke nipple as a connecting element may also consist largely or virtually completely or completely of metal, for example, of a light metal.

In particularly preferred embodiments, the cross-sectional portion of a connecting element made from fiber composite material comprises the same matrix material as the cross-sectional area. This means, in particular, that the identical or even the same matrix material is used in the short fiber area and in the long fiber area. This then means that the matrix material of the spoke is preferably uniform overall.

Thus, the same matrix material or the same material type of matrix material may be used in the entire spoke and in the entire spoke nipple. Preferably, at least one matrix material of the same type is used, which enters into a material connection. A boundary layer is particularly preferably not visible even in a micrograph. Where appropriate, it is also possible that slightly different matrix materials are used. It is particularly preferred that the basic components of the matrix material are identical.

It is particularly preferred that the material of the reinforcing elements of the spoke and/or of the spoke nipple is uniform overall. However, it is thereby possible and preferred that the material of the reinforcing elements in the cross-sectional portion differs at least partially from the material of the reinforcing elements in the cross-sectional area. The differences consist then not only in shape and size, but also in the type and composition of the materials used. In particular, at least one part of the shorter reinforcing elements may consist of a different material than the long fibers. Thus, for example, carbon fibers may be used for the long fibers, while glass fibers are used as the short fibers, or glass particles are used, for example, in the area of a thread. At least one part of the shorter reinforcing elements preferably comprises glass fiber material.

In particularly preferred embodiments, the spoke and/or the spoke nipple are designed materially integrally. It is particularly preferred that no specific material boundary surfaces are located in the volume of the spoke body, as such occur, for example, during gluing or also during welding of two separate workpieces.

The cross-sectional area (long fiber area) preferably has, in at least one end portion, a cross section deviating from a rotationally symmetrical cross section. It is thus preferred that an encasing of the long fibers in the cross-sectional area has a cross section deviating from a rotationally symmetrical cross section. An “encasing” is thereby understood as an “envelope” or a (virtual) shape. An “envelope” surrounds the cross-sectional area, which contains the reinforcing elements or long fibers. The three-dimensional shape of the cross-sectional area is defined overall by the location of the reinforcing elements or long fibers. The “envelope” surrounds the reinforcing elements as closely as possible. The envelope illustrates only the structure; it is not, however, an actual layer.

In all refinements and embodiments, it is preferred that the deviating cross section has a shape, which is taken from a group of shapes, said group comprising a shape that is (roughly) a polygon, star-shape, oval, ellipse, or cone, or T-shaped or L-shaped or H-shaped, wherein the corners may be rounded. Using such configurations, the transmission of a higher torque is reliably guaranteed, which occurs, where appropriate, during fastening or calibrating the spoke.

An overall surface of the cross-sectional area remains particularly preferably identical, wherein the form changes at the transition to the deviating cross section.

For this purpose, the center piece is heated (at least) at its ends and, in preferred embodiments, at least one end is reshaped. The end of the center piece is then reshaped from an aerodynamic cross section into a round, angular, star-shaped or also oval cross section or the like, in order to facilitate a stronger holding of the spoke.

The long fibers contained in the cross-sectional area are thereby also pressed or moved into the new, deviating, cross-sectional shape. The end piece is then integrally formed around this (where appropriate, complex) geometric shape.

An encasing of the long fibers in the center piece may thereby have a first shape. In simple cases, a round cross-sectional shape. In other preferred cases, e.g., an aerodynamic and, e.g., approximately oval cross-sectional shape, which forms the cross-sectional area in the center piece.

In the finished end piece, an encasing of the long fibers (of the cross-sectional area with a deviating cross section) may have a second shape, which significantly deviates from the first shape. E.g., the second shape at the end piece may have, in cross section, a largest longitudinal extension, which is aligned transversely or perpendicular to a largest longitudinal extension in a cross section at the center piece.

A cross-sectional surface of the encasing remains, in particular, (virtually) identical in both cross sections. The volume of the cross-sectional area is reshaped at the end piece. Stated differently, a cross-sectional surface of the long fibers in the end piece remains the same size as in the center piece; however, the shape of an encasing or the outer shape of the cross-sectional area changes in the end piece.

If, e.g., an oval or round surface of the cross-sectional area is present in the center piece, and this is reshaped at the end piece and aligned ovally and transversely thereto, the axial load capacity of the spoke increases.

A cross-sectional profile, retaining the same cross-sectional surface from the center piece into the end piece, may change from a horizontal ellipse to a vertical ellipse, by which means the tensile strength of the spoke body is improved.

In general, during the assembly of the spoke systems in a wheel, the spokes are set under tension in such a way that, in regular operation, a significant tensile stress is always present within the spoke at every occurring load.

In one embodiment, the cross-sectional portion is preferably accommodated centrally in the end piece and has a cone-like portion. It is then possible that long fibers surround the cone-like portion in the end piece.

The cross-sectional portion preferably radially surrounds the cross-sectional area (long fiber area) and the cross-sectional portion forms a thickening at the end piece.

It is particularly preferred that the threaded portion is designed at the cross-sectional portion (with shorter reinforcing elements).

It is particularly preferred that the long fibers extend through a central area of the center piece and through at least a central area of an end piece. The end piece with the threaded portion may comprise a central area, through which the long fibers extend, and an annular area, in which the thread is shaped and in which shorter reinforcing elements (or, where appropriate, no reinforcing elements at all) are introduced.

Preferably, a matrix material used in the cross-sectional area is, in particular, reversibly reshapable by thermal action. It is particularly preferred that a reversibly reshapable matrix material is included in the spoke body as a whole.

In all embodiments, it is particularly preferred that a thermoplastic matrix material is included in the cross-sectional area. It is particularly preferred that a thermoplastic matrix material is included in the spoke body as a whole. It is particularly preferred that at least (only) one thermoplastic matrix material is used in the spoke body.

In preferred embodiments, a wheel component further comprises a rim and a hub, which are (detachably) connected to one another via multiple separate spoke systems.

The spoke nipples may consist or be manufactured from a fiber composite material or also consist or be manufactured partially or also completely from a metal. A spoke nipple is preferably also manufactured from at least one fiber composite material and comprises, in particular, at least one matrix material and reinforcing elements embedded therein. In the case of the spoke, the end pieces are designed, in particular, integrally with the center piece and respectively form an end of the spoke.

The center piece of the spoke is preferably shaped according to a specific area of use. In preferred embodiments, the center piece of the spoke is aerodynamically shaped. This enables a low air resistance at low weight. The end piece in the spoke is accommodated at least virtually completely or completely within the rim. This enables a particularly advantageous configuration, in which the aerodynamic center piece extends up to the rim. A transition area is then not necessary. Because the greatest speeds relative to the surroundings occur particularly in the radially outermost area of the spoke at the rim, an aerodynamic configuration there is particularly advantageous. This is enabled by the invention.

Preferably, at least one spoke nipple made from a fiber composite material is used and screwed to the spoke. It is particularly preferred that all spokes and all spoke nipples are manufactured from fiber composite material.

It is particularly preferred that the material of the rim and also the material of the housing of the hub comprises fiber composite material and/or metal.

A further wheel component according to the invention for a vehicle, and in particular for bicycles, comprises a connecting element of a spoke system, namely a coupling element. The coupling element may be designed, in particular, as a spoke nipple. The coupling element is suitable for connecting, and is thus connectable, to a connecting element designed as a spoke. The coupling element has a thread. The coupling element is connectable to a spoke via the thread. The thread is designed as an inner thread, in order to connect an outer thread of a spoke to the inner thread of the coupling element. A free inner diameter of the inner thread of the coupling element thereby increases across at least a (significant) part (of an axial threaded length of the thread). The inner diameter of the inner thread may have, e.g., a conical profile. By this means, the strength of the connection of the spoke system may be increased. The wheel component is, in particular, part of a previously described wheel component.

Additional advantages arise from the exemplary embodiments, which are subsequently explained in greater detail with reference to the appended figures.

As shown in the figures:

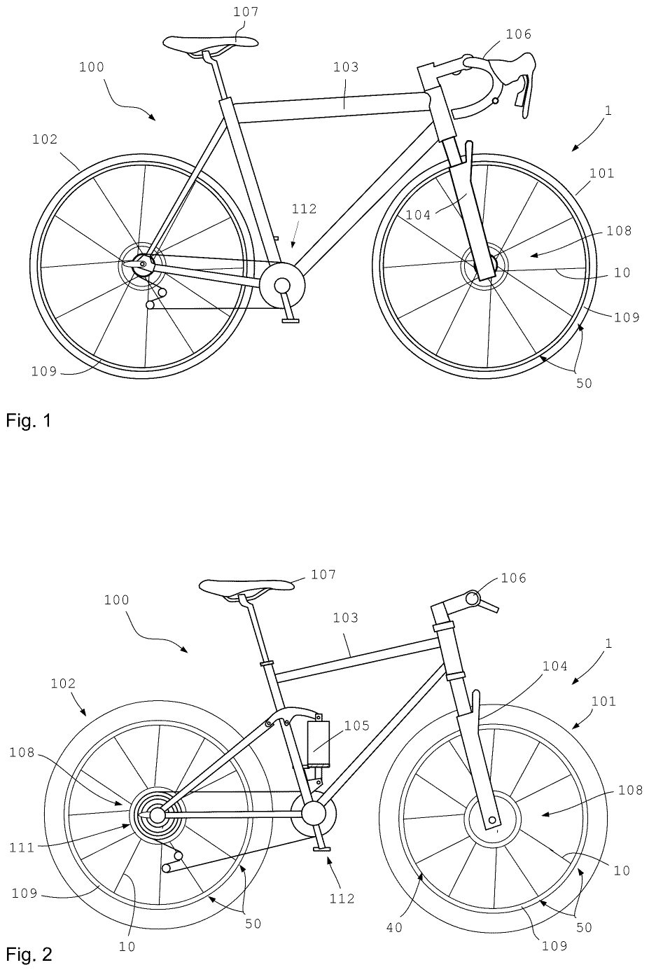

FIG. 1 a schematic depiction of a racing bike;

FIG. 2 a schematic depiction of a mountain bike;

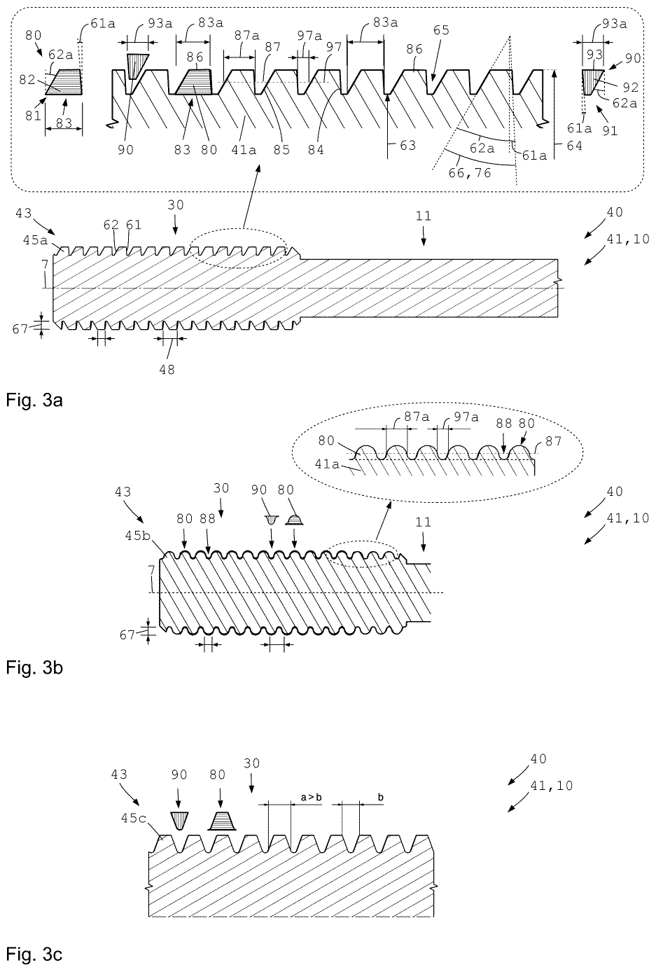

FIGS. 3a-3c schematic depictions of spokes as connecting elements of spoke systems according to the application;

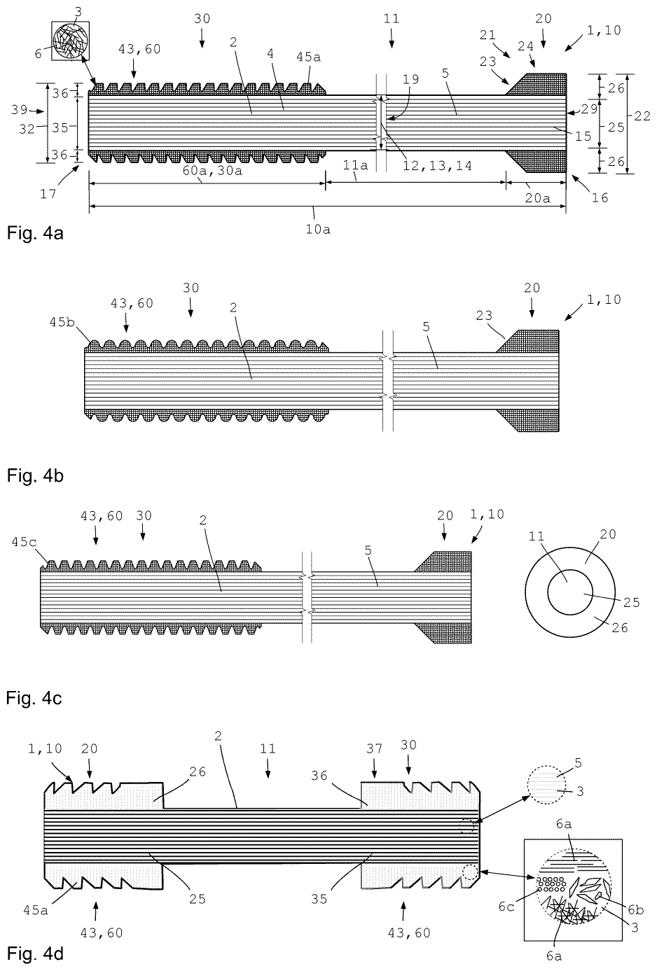

FIGS. 4a-4d schematic sectional views of spokes of spoke systems according to the application;

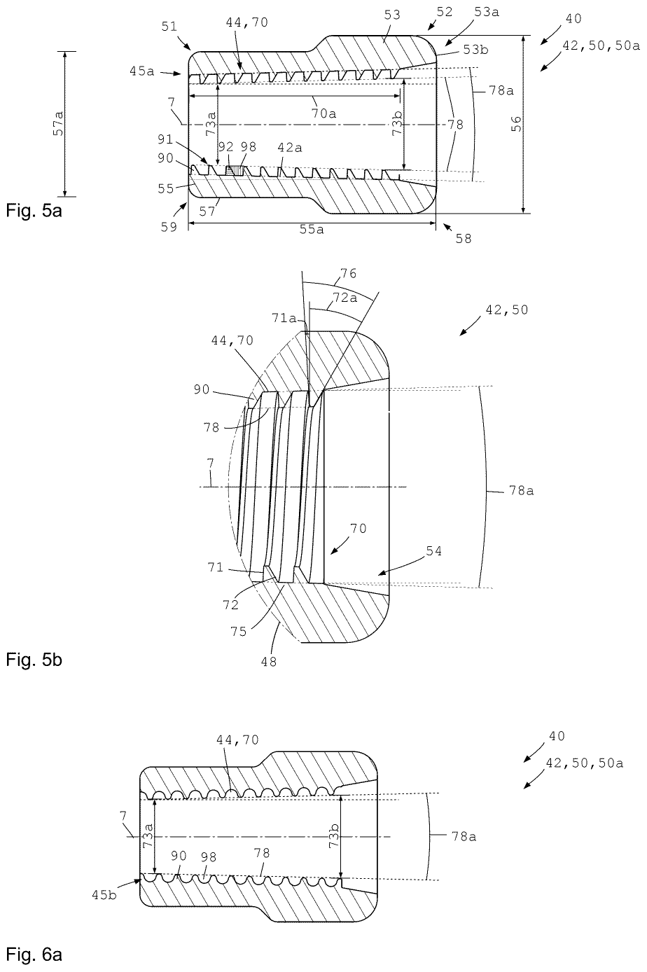

FIGS. 5a-7c schematic depictions of spoke nipples as connecting elements of spoke systems according to the application; and

FIGS. 8a-11a schematic depictions of spokes of spoke systems according to the application in the assembled state.

A mountain bike or a gravel bike and a racing bike 100 are respectively shown in FIGS. 1 and 2, which are respectively equipped with wheel components 1 according to the invention having spoke systems 40. The mountain bike or the racing bike 100 respectively has a front wheel 101 and a rear wheel 102.

The two wheels 101, 102 have spokes 10 as connecting elements 41, which interact with spoke nipples 50 as connecting elements 42 (see FIGS. 3 a-7a). A sprocket device 111 is provided. In principle, conventional rim brakes or also other brakes, like disc brakes, for example, may be provided.

The bicycles 100 respectively have a frame 103, handlebars 106, a seat 107, a fork or suspension fork 104, and, in the case of the mountain bike or a racing bike or gravel bike, a rear wheel suspension 105 may be provided. A pedal crank 112 with pedals functions as the drive. Where appropriate, an electric auxiliary drive may be provided at the pedal crank 112 and/or at the wheels. The hub of the wheels may respectively be fastened to the frame via a tensioning device like a through axle or quick release, for example.

Wheel components 1 according to the application having spokes 10 and spoke nipples 50a are visible in FIGS. 1 and 2.

The spokes connect the hub 108 to the rim 109. In this case, the spoke nipples 50a are accommodated in the interior of the double wall rim 109, so that they are not visible in the side view.

Different wheel components 1 according to the application are depicted in FIGS. 3 a to 11 a. A wheel component 1 has spoke systems 40 with spokes 10 and coupling elements 50 in the form of, e.g., spoke nipples 50a (see, e.g., FIG. 5a).

A top view of a spoke 10 of a spoke system 40 is respectively depicted in FIGS. 3a, 3b, and 3c. The spoke 10 has a center piece 11 and extends straight in the axial direction 7. The end piece 30, visible in this case, respectively has an outer thread 60 as a thread 43. The end portion has, in this case, a larger outer diameter than the center piece 11.

An enlarged detail of the thread 43 or outer thread 60 is depicted above FIGS. 3a and 3b respectively. The spoke 10, as spoke unit or connecting element 41, has a base body 41a with an outer thread 60 projecting radially outwardly therefrom. In the depicted cross section, the teeth 80 project from the base body 41a between two thread roots 65. The teeth 80 are designed substantially identically and have a base 83 at the core diameter 63. The tooth 80 with its tooth flanks 84 and 85 extends radially outward. The crest 86 of the tooth 80 forms the radially outer end.

The tooth shape 81 and its cross section 82 differ in FIGS. 3 a to 3 c. A type of sawtooth thread 45 a is depicted in FIG. 3a, in which a thread flank 61 is aligned at a shallow angle 61a and the other thread flank 62 is aligned at a greater angle. A type of round thread 45b is depicted in FIG. 3b, and a type of trapezoidal thread 45c in FIG. 3c. The thread depth 67 and the thread pitch 48 are marked.

One tooth 80 is respectively depicted with hatching in FIGS. 3a to 3c in order to clarify the cross section 82 of the respective tooth shape 80. Furthermore, one hatched tooth 90, engaging in the outer thread 60, of a spoke nipple 50a (not otherwise depicted in FIGS. 3a to 3c, see, e. g., FIG. 5a) is depicted for clarification. The interdental spaces 88 are largely (and substantially completely) filled in by the engagement of a tooth 90 or the thread. The tooth 90 extends from its base 93 on the base body 42a (see FIG. 5a) into the interdental space 88 between two teeth 80. The angles of the thread flanks correspond to the angles 61a, 62a.

The teeth 80 of the thread 43 of the spoke 10 extend radially outward from the core diameter 63 up to the outer diameter 64. In a radially middle area of the teeth (in particular at the flank diameter), the teeth 80 of the spoke 10 extend across a significantly greater axial distance 87a than the axial length 97a of the teeth 90 of the inner toothing 70.

Material differences may thus be compensated for, so that a virtually identical strength of the two connecting elements 41, 42 may be realized.

In FIG. 3b, the teeth 80 of the outer thread 60 of the spoke 10 have an outwardly rounded shape and also a larger axial length at the base. This also applies for the embodiment according to FIG. 3c, in which the teeth 90 have a type of trapezoidal shape.

Due to the different cross sections 82, 92 of the teeth 80, 90, material differences and, where appropriate, structural differences may be compensated for.

Correspondingly complete schematic cross sections of spokes 10 as connecting elements 41 of spoke systems 40 are depicted in FIGS. 4a to 4c. FIG. 4a shows a spoke 10 with a type of sawtooth thread 45a, FIG. 4b a spoke 10 with a type of round thread 45b, and FIG. 4c a spoke 10 with a type of trapezoidal thread 45c.

The spoke 10 in FIGS. 4a to 4c respectively has an end piece 20 without threads having a head portion 21, which is, e.g., conically designed as a thickened portion 23 and may then connect to a support portion 24. The other end piece 30 then respectively has an outer thread 60 as a thread 43 over a length 60a. It is also possible that both end pieces respectively have a thread. It is clear in each case that the central area 19, with the length 10a, extends respectively completely through the spoke 10. In the end piece 20, the central area 19 may be designated as central area 29. In the end piece 30, the central area 19 may be designated as central area 39.

In the central areas 19, 29, 39, long fibers 5 are incorporated in the fiber composite material 2 as reinforcing elements 4 in the matrix material 3. The long fibers 5 extend integrally (and “endlessly”) from one end of the spoke 10 to the other end.

At the end piece 20, 30, the central area 29, 39 is radially surrounded by a cross-sectional portion 26, 36. The central area 29, 39 forms a cross-sectional area 25, 35, the long fiber area. There are only a few or preferably no long fibers 5 contained in the cross-sectional portion 26, 36 surrounding it. There may be no reinforcing elements 4 at all provided in the cross-sectional portion 26, 36, but instead only pure matrix material 3. It is possible and also preferred that shorter reinforcing elements 6 are contained in the cross-sectional portion 26, 36. The shorter reinforcing elements 6 may be designed as short fibers 6a, as is clear in the upper left in FIG. 4a. It is also possible that short fibers 6a and/or fiber snippets 6b and/or reinforcing particles 6c are contained in a cross-sectional portion 26, 36, as FIG. 4d vividly shows in an enlargement on the right side. Taken together, the result for the spoke body 15 of the spoke 10 is an outer diameter 22 at the end piece 20 at the end 16 and an outer diameter 32 at the end 17 of the end piece 30.

In simple embodiments, the center piece 11 is designed as round, at least in the central area 19, so that the minimum transverse dimension 12, the average transverse dimension 13, and the maximum transverse dimension 14 respectively have the same value, and correspond in this case to the diameter of the center piece 11. In other embodiments, the spoke 11 may be designed, e.g., aerodynamically, so that the minimum, average, and maximum transverse dimension 12-14 respectively differ from one another.

Different embodiments of spoke nipples 50a are depicted in FIGS. 5a to 7a as coupling elements 50, which respectively form a connecting element 42 of a spoke system 40.

FIGS. 5a to 7a show schematic cross sections through a spoke nipple 50 a as a connecting element 42 of the spoke system 40 in cross section, wherein the inner thread 70 is visible as thread 44 on the inside, and the thickened end area on the right end portion 52, with which the spoke nipple 50 is supported within a rim. In this case, the nipple is supported with the thickened end area 53 on the right end 52.

In FIG. 5a, the spoke nipple 50a has a nipple body 55, which extends across a length 55a, which may be, for example, 10 mm. Somewhat shorter and also somewhat longer embodiments are also possible. The nipple body 55 has a larger length 55a than a diameter 56 of the nipple body.

The nipple body has end portions 51 and 52 on the ends 58 and 59. At the end 58 in FIG. 5a, the nipple head 53 is designed with the head end 53a, which is designed as rounded, and the contact surface 53b is provided, on which the nipple is supported, for example, on the rim.

A receptacle 54 (insertion aid) for the threaded end of a spoke is designed on the nipple head 53. An inner thread 70 is designed in the receptacle. The nipple head 53 may be screwed onto a spoke end via the thread 44. The receptacle 54 may be designed as a through opening. It is also possible that the other end 51 is partially or completely closed. The receptacle 54 is then a blind hole.

A spoke nipple 50a is depicted in FIG. 5a which has a type of sawtooth thread 45a as inner thread 70. The inner thread 70 is designed asymmetrically in the radial direction. The cross sections of teeth 90 of the spoke nipple 50a have a different tooth shape 91 and a different cross section 92 than the teeth 80 of the spoke 10 interacting therewith. The teeth 80, 90 differ with respect to the dimensions and also the tooth shape. Together, the teeth 80 and 90 largely fill the intermediate space between spoke 10 and spoke nipple 50a in each case.

The inner thread 70 is designed as conical and has an opening angle 78 a, which in this case is approximately 3°; however, it may also be larger or smaller. The outer thread 60, interacting therewith, of a spoke 10 is, e.g., designed as cylindrical and may have a cylindrical core diameter 63 and a cylindrical outer diameter 64 (see e.g., FIG. 4a). It is also possible that an outer thread of a spoke 10 is designed as slightly conical.

The inner contour 78 of the spoke nipple 50a is likewise designed a conical or trumpet-like. The shape arises from the opening angle 78a. The opening angle 78a may vary across the length of the spoke nipple 50a, and may be, e.g., larger toward an axial end. The inner contour 78 is then not precisely conical, but instead designed as more trumpet-like. The inner contour 78 increasingly expands. The inner contour connects the points or edges, which project radially farthest inward. Usually, with the crests 96 of the teeth 90 or the radially inner contours of the thread 70.

The inner thread 70 extends across a thread length 70a. In this case, on the right end portion 52, a thickened nipple head 53 is designed, which is designed as rounded, in order to be supported on a rim. The coupling element 50 and, in this case, the spoke nipple 50a has a head end 53a with a contact surface 53b for supporting on a rim. A radial depth of engagement 49 decreases in the direction toward the head end 53a in the assembled state.

One tooth 90 is highlighted by hatching. An adjacent interdental space 98 is marked, which has a different cross section and different dimensions. A clear inner diameter 73a at the left end 51, in this case, is smaller than the free inner diameter 73b on the other end of the thread 70. Thus, in the case of a screwed-in spoke 10 with a cylindrical outer thread, a radial depth of engagement 49 varies across the length of the spoke nipple 50a.

FIG. 5b shows an enlarged depiction of the end portion 52 from FIG. 5a in a complete sectional view. The asymmetrical angles 71a, 72a of the tooth flanks or the thread flanks 71, 72 are clearly visible. The flank angle 76 (or 66) is composed of the angles 71a and 72a (61a, 62a). A thread root 75 is visible between two teeth 90.

FIG. 6a shows a spoke nipple 50a, which, unlike the exemplary embodiment according to FIG. 5a, has a type of round thread. The inner thread 70 is designed as conical and opens in the direction of the spoke to be screwed in. The opening angle 78a is marked. In this case as well, there arises a variable radial depth of engagement across the engagement length.

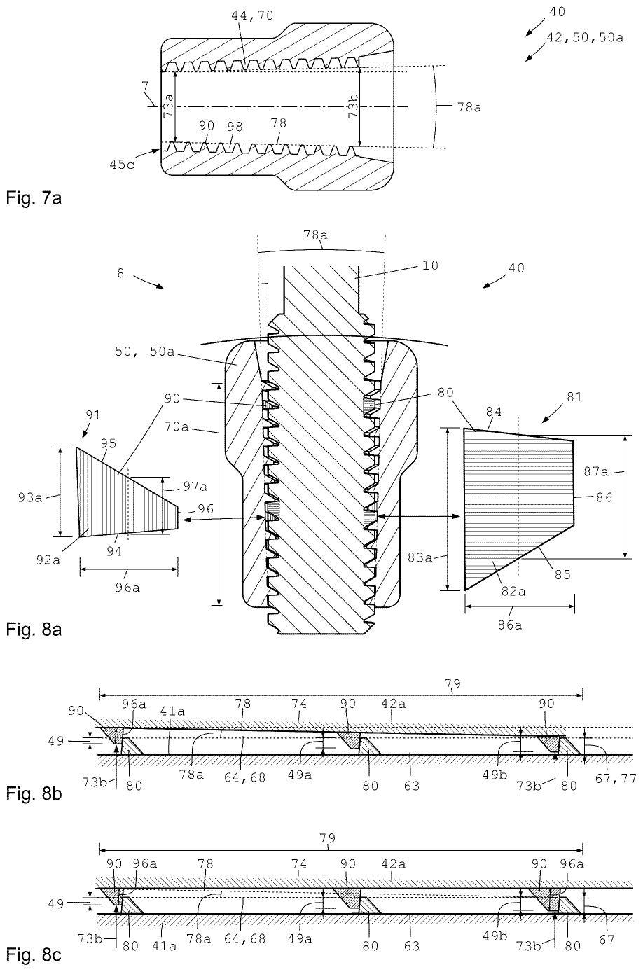

FIG. 7a depicts a spoke nipple 50a, which has a type of trapezoidal thread. The inner thread 70 is designed as conical and opens in the direction of the spoke to be screwed in. The opening angle 78a of an inner contour 78 is marked.

In FIGS. 8a to 10b, variants of spoke systems 40 according to the application are depicted in the assembled state 8.

FIG. 8a shows the assembly of the spoke nipple 50a from FIG. 5a with a spoke 10 from FIG. 3a having a conical inner thread 70. The threads 43, 44 are designed as radially asymmetrical sawtooth threads. Enlarged cross sections 82, 92 of the teeth 80, 90 are depicted to the left and right next to the sectional view. The teeth 80, 90 respectively extend radially outward or radially inward from a base 83, 93. The tooth flanks 84, 85 or 94, 95 run at different angles to the crest 86, 96. The tooth height 86a, 96a is respectively identical. The cross-sectional surfaces 82a, 92a of the cross sections 82, 92 differ significantly. Thus, the tooth 80 of the outer thread 60 has a much larger axial length 83a at the base 83 than the tooth 90. The axial length 93a at the base 93 is only about half as long in this case. Thus, the strength may be significantly adapted to the material used. The axial length 87a at a radially middle area (of the tooth height 86a or 96a) is significantly larger that the corresponding axial length 97a of the teeth 90.

FIGS. 8b and 8c show schematic views of the engagement of the teeth 80, 90 with one another, wherein the inner thread 70 has an opening angle 78a. The inner thread is designed as conical in FIG. 8b. The teeth 90 respectively have an identical tooth height. A thread depth 67, 77 is constant in this case and also identical in this case. Due to the conicity, a variable radial depth of engagement 49 results, which changes in this case approximately linearly from a low overlap at the radial depth of engagement 49 through the average radial depth of engagement 49a to the (virtually) complete overlap at the radial depth of engagement 49b. The height of the individual teeth 80, 90 remains constant. The outer diameter 64 of the teeth 80 defines an outer contour 68. Where appropriate, an opening angle arises at the outer contour 68, if this runs, e.g., slightly conically.

In FIGS. 8b and 8c, only three individual teeth 80, 90 are depicted by way of example across an engagement length 79 of the threads. In reality, the thread turns contact one another densely and without play. In this case, the radial depth of engagement 49 is depicted highly schematically, and not as an exact sectional view. Therefore, teeth 80, 90 were left out.

A variant is highly schematically depicted in FIG. 8c, in which the tooth height 96a increases across the teeth 90 from left to right. The respective core diameter 63, 74 remains, e.g., constant, and the tooth height 96a (in this case only for the teeth 90) changes, so that the overlap or the radial depth of engagement 49 of the teeth 80, 90 varies across the engagement length 79. A tooth height 86a of the teeth 80 remains constant in this case (or changes less than a tooth height 96a of the teeth 90). The free inner diameter changes from a value 73a to a value 73b.

In both embodiments according to FIG. 8b and FIG. 8c, the radial depth of engagement 49 of the windings of the threads varies over the engagement length 79. This has the effect that an effective distribution of the load of the connecting elements 41, 42 is carried out. Especially when using different materials for the connecting elements 41, 42, an optimal distribution of the load may be carried out. The strength may be increased. The creep behavior may be improved.

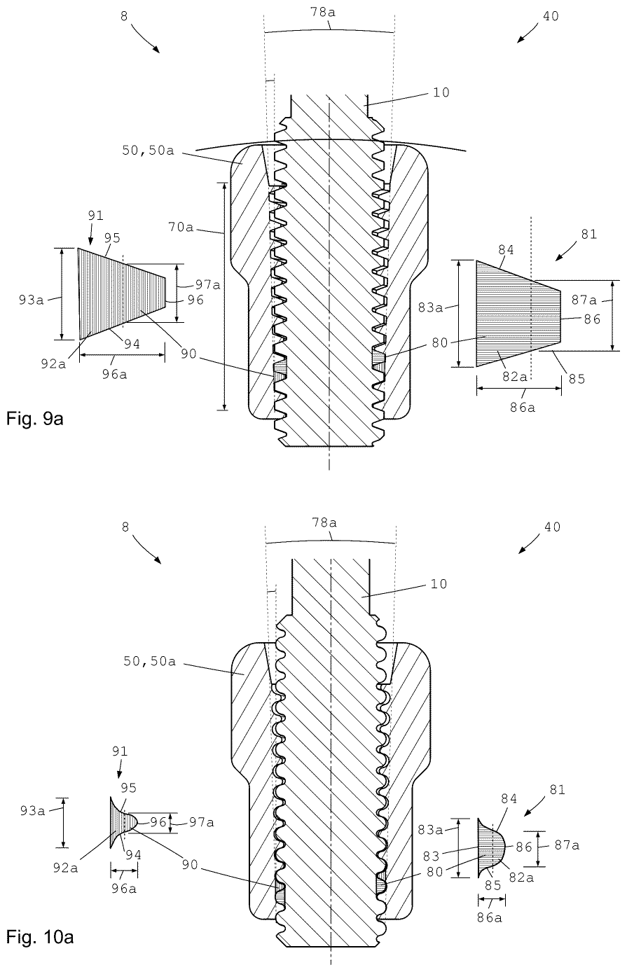

FIG. 9a shows an assembly of a spoke 10 and a spoke nipple 50a of a spoke system 40, wherein the threads 43, 44 are designed as a trapezoidal thread. In this case as well, the teeth 80, 90 have significantly different cross sections 82, 92 and different tooth shapes 81, 91. The axial length 83a of the teeth 80 at the base 83 is significantly larger than the axial length 93a of the teeth 90 at their base 93. This also applies for a radially middle point 87 or 97 with an axial length 87a or 97a. The inner thread 70 is designed as conical and has a conical profile on the core diameter and at the free inner diameter. The outer thread 60 of the spoke 10 is designed as cylindrical; however, it might also be designed as slightly conical.

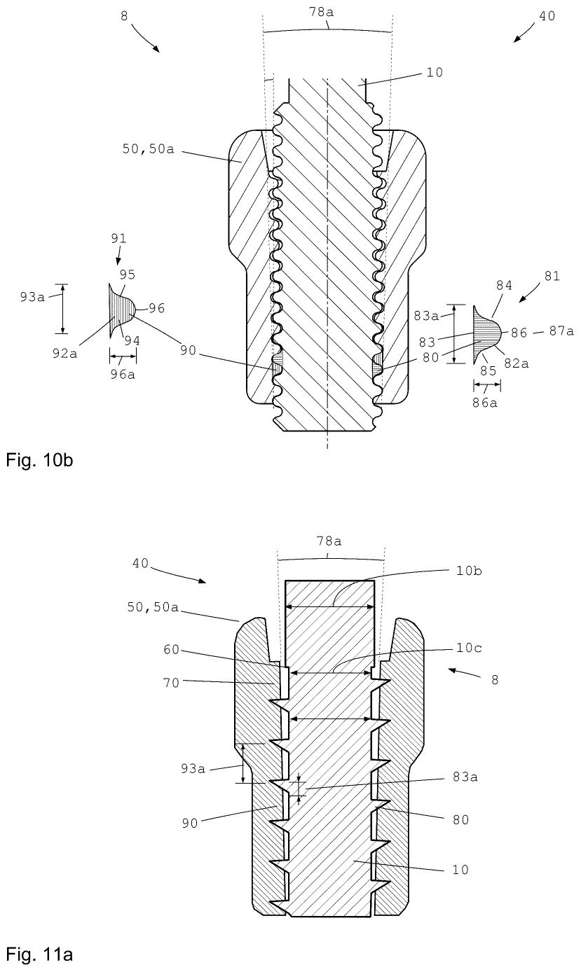

FIG. 10a shows an assembly of a spoke 10 according to FIG. 3b with a spoke nipple 50a according to FIG. 6a. The threads 43, 44 are designed in this case as a type of round thread. In this case as well, the teeth 80, 90 have significantly different cross sections 82, 92, with different cross-sectional surfaces 82a, 92a and different tooth shapes 81, 91. The axial length 83a of the teeth 80 at the base 83 is significantly larger than the axial length 93a of the teeth 90 at their base 93. This also applies for a radially middle point 87 or 97 with an axial length 87a or 97a. The inner thread 70 is designed as conical and has a conical profile on the core diameter and at the free inner diameter. The outer thread 60 of the spoke 10 is designed as cylindrical; however, it might also be designed as slightly conical.

A variant of the exemplary embodiment from FIG. 10a is depicted in FIG. 10b. The threads 60, 70 are respectively designed as symmetrical in FIG. 10b. The inner thread 70 in the spoke nipple 50a is designed as conical. The radial depth of engagement thus decreases in the axial direction toward the hub across the engagement length 79. The teeth 80 and 90 are designed congruently in principle.

FIG. 11a shows an embodiment, in which the spoke 10 is manufactured, e.g., from a metallic material. The outer thread 43 of the spoke 10 may be rolled, wherein the minimum outer diameter 10c is thereby smaller than the base diameter 10b. The volume for the teeth 80 is thus provided during the rolling. The axial tooth length 83a is, in this case, significantly shorter than an axial length 93a of the tooth 90 of the spoke nipple 50a.

Overall, the spoke system 40 may reliably transfer high forces and may also be designed as self-locking. A gluing of the spoke and the spoke nipple is therefore not necessary. The absence of adhesive improves and simplifies the maintenance options. A testing and adjustment of the spoke tension may be carried out at any time.

By using spoke nipples 50a made from fiber composite material, a lighter spoke nipple may be provided, which in turn also reliably prevents a potential contact corrosion of different metals with one another. In particular, if reinforcing elements with a glass fiber content are used, then such problems are reliably prevented. It is also possible to use spoke nipples made from metal or other materials together with spokes made from fiber composite material.

It is further possible to design a sawtooth thread on both connecting elements, and to configure the teeth of the coupling element as significantly wider (longer in the axial direction) than the teeth of the spoke. This may be useful for spokes, e.g., made from metallic materials, which are generally fastened with coupling elements, or specifically with spoke nipples, made from other materials. E.g., spoke nipples made from thermoplastic materials with or without reinforcing elements. Or spoke nipples made from fiber composite material with a thermoplastic matrix, or also with other matrix materials.

Coupling elements made from non-metallic materials have advantages, if they are in contact with other metallic materials on other wheel components (rim, hub, etc.).

A more stable connection is enabled using a radial depth of engagement changing across the engagement length. A better stability is achieved precisely by combining different materials and/or by using fiber composite materials or plastics or matrix materials. By using thermoplastic matrix materials, an improved spoke system may be provided.

### List of Reference Numerals

1 Wheel component
2 Fiber composite material
3 Matrix material
4 Reinforcing elements
5 Long fibers
6 Shorter reinforcing elements
6a Short fibers
6b Fiber snippets
6c Reinforcing particles
7 Longitudinal axis, axial direction
8 Assembled state
10 Spoke
10a Length of 10
10b Base diameter
10c Minimum diameter
11 Center piece
11a Length of 11
12 Transverse dimension (minimum)
13 Transverse dimension (average)
14 Transverse dimension (maximum)
15 Spoke body
16 End
17 End
19 Central area
20 End piece
20a Length of 20
21 Head portion
22 Outer diameter
23 Thickened portion
24 Support portion, cylindrical section
25 Cross-sectional area
26 Cross-sectional portion
28 Cone-like portion
29 Central area
30 End piece
30a Length of 30
32 Outer diameter
35 Cross-sectional area, long fiber area
36 Cross-sectional portion, short fiber portion
37 End portion
39 Central area
40 Spoke system
41 Connecting element, spoke unit
41a Base body
42 Connecting element, spoke unit
42a Base body
43 Thread, outer thread
44 Thread, inner thread
45a Sawtooth thread
45b Round thread
45c Trapezoidal thread
48 Thread pitch of 43, 44
49 Radial depth of engagement
49a Radial depth of engagement
49b Radial depth of engagement
50 Coupling element
50a Spoke nipple
51 End portion
52 End portion
53 Nipple head
53a Head end
53b Contact surface
54 Receptacle
55 Nipple body
55a Length
56 Diameter
57 Tool contact
57a Width across flats
58 End (rounded)
59 End (tool end)
60 Outer thread
60a Thread length
61 Thread flank (shallower)
61a Angle (shallower)
62 Thread flank (steeper)
62a Angle (steeper)
63 Core diameter, minimum diameter
64 Outer diameter, maximum diameter
65 Thread root
66 Flank angle
67 Thread depth
68 Outer contour
68a Opening angle
70 Inner thread
70a Thread length
71 Thread flank (shallower)
71a Angle (shallower)
72 Thread flank (steeper)
72a Angle (steeper)
73a Free inner diameter
73b Free inner diameter
74 Core diameter, maximum diameter
75 Thread root
76 Flank angle
77 Thread depth
78 Inner contour
78a Opening angle
79 Engagement length
80 Tooth
81 Tooth shape
82 Cross section
82a Cross sectional surface
83 Base
83a Axial length
84 Tooth flank
85 Tooth flank
86 Crest
86a Tooth height
87 Radially middle point
87a Axial length
88 Interdental space
90 Tooth
91 Tooth shape
92 Cross section
92a Cross sectional surface
93 Base
93a Axial length
94 Tooth flank
95 Tooth flank
96 Crest
96a Tooth height
97 Radially middle area
97a Axial length
98 Interdental space
100 Bicycle
101 Wheel, front wheel
102 Wheel, rear wheel
103 Frame
104 Fork, suspension fork
105 Rear wheel suspension
106 Handlebars
107 Seat
108 Hub
109 Rim
111 Sprocket device
112 Pedal crank

1. A wheel component for bicycles, comprising: a spoke system having two interacting connecting elements, namely having a connecting element loaded in tension during operation and designed as a spoke, and having at least one connecting element designed as a coupling element;
wherein the spoke extends in the axial direction and comprises a center piece and two end pieces in order to detatchably connect the spoke to a hub or to a rim by means of the end pieces;
wherein the two connecting elements, namely the coupling element and the spoke, have interacting threads in order to connect the spoke and the coupling element to one another, wherein one of the threads is designed as an inner thread and one of the threads is designed as an outer thread;
in the assembled state, a radial depth of engagement of the two threads screwed to one another increases across at least one part of an axial threaded length, and in the assembled state, the radial depth of engagement increases by at least 25% across the threaded length.

2. The wheel component according to claim 1, wherein the radial depth of engagement of the two threads in the assembled state decreases in the axial direction toward the spoke center.

3. The wheel component according to claim 1, wherein the inner thread has an increasing free inner diameter across at least one part of the axial threaded length, and is designed, e.g., as conical, so that a radial depth of engagement of the threads increases in the axial direction.

4. The wheel component according to claim 1, wherein the coupling element has a head end with a contact surface for support, and wherein the radial depth of engagement decreases in the direction toward the head end.

5. The wheel component according to claim 1, wherein a free inner diameter of the inner thread increases/decreases across an axial length of the inner thread in the coupling element.

6. The wheel component according to claim 1,
wherein an inner contour of the inner thread in the coupling element is designed as approximately conical;
and wherein an opening angle of the inner contour of the inner thread is between 1° and 7°;
and wherein the inner contour of the inner thread in the coupling element is designed as conical in the direction of the spoke.

7. The wheel component according to claim 1, wherein a core diameter of the inner thread in the coupling element runs conically in the axial direction.

8. The wheel component according to claim 1, wherein both threads are designed as conical at least in portions, wherein an opening angle of the one thread is significantly larger than an opening angle of the other thread.

9. The wheel component according to claim 1, wherein an opening angle of the thread of the spoke is less than 1°.

10. The wheel component according to claim 1, wherein the other of the two threads is designed as substantially cylindrical.

11. The wheel component according to claim 1, wherein a core diameter of the inner thread in the coupling element changes less than the free inner diameter of the inner thread.

12. The wheel component according to claim 1, wherein the connecting elements respectively have, in the area of the threads, a base body and teeth projecting radially outwardly or inwardly therefrom, and that a tooth shape of the thread of the spoke differs significantly from a tooth shape of the thread of the coupling element in order to increase the strength of the connection of the spoke system.

13. The wheel component according to claim 12, wherein at least the teeth of the connecting elements consist at least partially of different materials;
and wherein the strength of the two threads differs by less than 50%.

14. The wheel component according to claim 1, wherein at least one thread is designed as asymmetrical in the axial direction.

15. The wheel component according to claim 1, wherein the coupling element comprises at least one metallic material.

16. The wheel component according to claim 1, wherein the spoke consists at least partially of a metallic material and the coupling element consists at least partially of a thermoplastic or duroplastic material, and in particular of a fiber composite material having at least one matrix material and reinforcing elements.

17. The wheel component according to claim 1, comprising a rim and a hub, which are connected to one another via multiple separate spoke systems.

18. A wheel component for bicycles, comprising: a connecting element of a spoke system, namely a coupling element, suitable for connecting to a connecting element designed as a spoke;
wherein the coupling element has a thread, wherein the thread is designed as an inner thread in order to connect an outer thread of a spoke to the inner thread of the coupling element;
a free inner diameter of the inner thread of the coupling element increases and, has a conical profile over at least a significant part of the axial threaded length.
